(19) United States
(12) Patent Application Publication
(10) Pub. No.: US 2023/0127583 A1
(43) Pub. Date: Apr. 27, 2023

(54) Model Predictive Control Systems and Methods

(71) Applicant: University of New Brunswick, Fredericton (CA)

(72) Inventors: Meaghan Charest-Finn, Oshawa (CA); Rickey Dubay, Fredericton (CA); Ryan Finn, Fredericton (CA)

(73) Assignee: University of New Brunswick, Fredericton (CA)

(21) Appl. No.: 17/907,787

(22) PCT Filed: Mar. 1, 2021
(86) PCT No.: PCT/CA2021/050261

§ 371 Date: Aug. 29, 2022

(30) Foreign Application Priority Data
Feb. 27, 2020 (CA) 62982475

(51) Int. Cl. G05B 13/04

(52) U.S. Cl. CPC G05B 13/048

(57) ABSTRACT

MPC controller systems and methods are disclosed that may be applied to various different types of MPC controllers and methods for use in any desired or appropriate controller settings, such as physical systems with non-linearities that require careful modelling tactics, which are considered complex systems. Complex systems include fast systems which are those where solving the descriptive model of the system has the potential to surpass the closed loop sampling time required to control the system. Examples of complex fast systems are robot manipulators, quadracopters and injection speed of an injection molding process.

### TECHNICAL FIELD

This application relates to process control performed in, for example, fast systems and, more particularly, relates to improved model predictive control (“MPC”) systems and methods.

### DESCRIPTION OF BACKGROUND TECHNOLOGY

Industrial automation has been rapidly changing during the current industrial revolution, I4.0 [1]. The rise of cyber physical systems is a testament to the increased role that industrial automation plays in modern factories [2]. Specifically, the ability to properly model systems with machine learning tools to predict outcomes is pushing the boundaries of practical control applications [3]. New implementations and case studies show the need for the development of I4.0 methodologies that can be readily integrated into existing physical systems [4], [5].

Physical systems with non-linearities that require careful modelling tactics are considered complex systems. Fast systems are those where solving the descriptive model of the system has the potential to surpass the closed loop sampling time required to control the system. Examples of complex fast systems are robot manipulators, quadracopters and injection speed of an injection molding process. MPC algorithms are uniquely suited for the practical implementation of machine learning modelling tools in these types of systems. The model component of the control algorithm provides the capacity for optimal decision making over a large prediction horizon; this can lead to improved robust control over other control methodologies [6]. Additionally, the model serves as a point of connection for machine learning tactics to be integrated into an existing system, as shown in [7]. While it is important to have accurate models for high performance control, complex models can require significant processing times. This is a key challenge in implementing intelligent control schemes, more so when considering fast complex systems where control moves must be evaluated every sampling instant.

There are many examples of MPC algorithms used to control complex systems that are fast [8]-[10]. One common course of action in mitigating the computational complexity of MPC calculation is to simplify the system model; examples of this can be found in [11]-[13]. Others have distributed the model computation to implement MPC methods [14]. There are also many other tactics that have been used to enhance the performance of MPC controllers, but they are often problem specific or require some model reduction technique, as mentioned in [7]. This can lead to prediction inaccuracies. Prediction inaccuracies can contribute to poor closed loop MPC performance.

### BRIEF DESCRIPTION OF THE DRAWINGS

FIG. 1 is a block diagram of a prior art MPC system;

FIG. 2 is a block diagram of an MPC system according to an aspect of the present disclosure;

FIG. 3 is a block diagram of an MPC system according to another aspect of the present disclosure;

FIG. 4 is a block diagram of an MPC system according to another aspect of the present disclosure;

FIG. 5 is a block diagram of an MPC system according to another aspect of the present disclosure;

FIG. 6 is a Bead-on-Hoop model;

FIG. 7 are graphs of a 2-dimensional trajectory for the bead of FIG. 6 for ω=3;

FIG. 8 is a 3-dimensional trajectory for the bead of FIG. 6 for ɯ=3;

FIG. 9 are graphs of a 2-dimensional trajectory for the bead of FIG. 6 for ω=8;

FIG. 10 is a 3-dimensional trajectory for the bead of FIG. 6 for ɯ=8;

FIG. 11 are graphs of a 2-dimensional trajectory for the bead of FIG. 6 for ω=8;

FIG. 12 is a 3-dimensional trajectory for the bead of FIG. 6 for ɯ=3;

FIG. 13 is a diagram of a vertical robot manipulator;

FIG. 14 is a graph of drop motion of the vertical robot manipulator of FIG. 13;

FIG. 15 is a graph of drop motion of the vertical robot manipulator of FIG. 13;

FIG. 16 is a graph of drop motion of the vertical robot manipulator of FIG. 13;

FIG. 17 is a graph of drop motion of the vertical robot manipulator of FIG. 13;

FIG. 18 is a graph of drop motion of the vertical robot manipulator of FIG. 13;

FIG. 19 is a graph of drop motion of the vertical robot manipulator of FIG. 13;

FIG. 20 is a graph of controlled plant response for the bead of FIG. 6 with a prior art standard MPC;

FIG. 21 is a graph of controlled plant response for the bead of FIG. 6 with a prior art adaptive MPC;

FIG. 22 is a graph of open loop responses used to create a dynamic matrix for the model of the trajectory of the bead of FIG. 6;

FIG. 23 are graphs of controlled plant response for the bead of FIG. 6 with a Split Model MPC according to an aspect of the present disclosure;

FIG. 24 is a graph of open loop responses for the model of FIG. 23;

FIG. 25 is a graph of processing time for the model of FIG. 23;

FIG. 26 is a graph of Injection Speed vs. Time for experiment results applying an MPC system and method according to an aspect of the present invention to an injection molding machine;

FIG. 27. is a graph of a comparison of control performance using three controllers, two prior art (standard MPC and adaptive MPC) and one controller according to an aspect of the present disclosure (Split Model MPC), to control the injection molding machine of FIG. 26;

FIG. 28 is a graph of a comparison of control errors for the three controllers of FIG. 25;

FIG. 29 is a graph of a comparison of control actions for the three controllers of FIG. 25;

FIG. 30 is a graph of a comparison of control loop execution time for the three controllers of FIG. 25;

FIG. 31 is a graph of a comparison of control loop execution time - close, for the three controllers of FIG. 26;

FIG. 32 are graphs of control performance using a prior art standard MPC to control the robot manipulator of FIG. 13;

FIG. 33 are graphs of control performance using a prior art adaptive MPC to control the robot manipulator of FIG. 13;

FIG. 34 are graphs of control performance using a controller according to an aspect of the present disclosure (Split Model MPC) to control the robot manipulator of FIG. 13;

FIG. 35 is a graph comparing processing times for the models of FIGS. 32, 33 and 34;

FIG. 36 is a comparison of the motion of the vertical robot manipulator of FIG. 13 using a prior art standard MPC; and

FIG. 37 is a comparison of the motion of the vertical robot manipulator of FIG. 13 using a prior art adaptive MPC.

### DETAILED DESCRIPTION

Generally speaking, new MPC controller systems and methods are disclosed herein that may be applied to various different types of MPC controllers and methods for use in any desired or appropriate controller settings, such as physical systems with non-linearities that require careful modelling tactics, which are considered complex systems. Complex systems include fast systems which are those where solving the descriptive model of the system has the potential to surpass the closed loop sampling time required to control the system. Examples of complex fast systems are robot manipulators, quadracopters and injection speed of an injection molding process.

In the present disclosure, MPC structures for controlling fast systems where complex models are beneficial is presented. In one embodiment, the model structure is called Split-Model MPC (SP-MPC) by the present inventors. The purpose of the structure as presented here is to mitigate large processing times so that complex modelling techniques such as machine learning methods can be leveraged to improve overall control performance. The simulation results presented here are based on the control of injection speed in a plastic injection molding machine (IMM).

In one embodiment, the present invention relates to a model predictive control system for controlling the operation of a physical system including at least one non-transitory memory operable to store program code, a model predictive control (MPC) controller including at least one processor operable to read the program code and operate as instructed by the program code, the program code including a first prediction model and an optimizer in a control loop, the program code causing the at least one processor to, in the control loop, measure a difference between an output of the first prediction model and a reference, calculate a correction parameter based on the measured difference, apply, at a first update rate, the correction parameter to the first prediction model output to update the first prediction model, and adjust the physical system based on the updated first prediction model, the program code further including a second prediction model, the program code causing the at least one processor to update the first prediction model using the second prediction model at an update rate different than the update rate of the first prediction model. In an embodiment of the model predictive control system, the second predictive model is more complex than the first predictive model. In certain embodiments of the model predictive control system, the update to the first prediction model using the second prediction model is carried out at regularly recurring intervals, in response to a triggering event where for example the triggering event can be a signal from a timer, or where the triggering event can be the receipt of a sampling input from the physical system. The model predictive control system can further include an update node for triggering an update of the first prediction model. In certain embodiments, in the model predictive control system, the physical system is a machine or a plant, such as a MIMO plant. In certain other embodiments, a plurality of MPC controllers and plants are connected to the second predictive controller.

In another embodiment, the present invention relates to a method for controlling the operation of a physical system using a model predictive control (MPC) controller, using at least one processor, the method including: in a control loop, generating a first prediction model, measuring a difference between an output of the first prediction model and a reference, calculating a correction parameter based on the measured difference, applying, at a first update rate, the correction parameter to the first prediction model output to update the first prediction model, and, adjusting the physical system based on the updated first prediction model, generating a second prediction model and updating the first prediction model using the second prediction model at an update rate different than the update rate of the first prediction model. In an embodiment of the method for controlling the operation of a physical system, the second predictive model is more complex than the first predictive model. In certain embodiments of the method for controlling the operation of a physical system, the update to the first prediction model using the second prediction model is carried out at regularly recurring intervals, in response to a triggering event such as a signal from a timer for example or the receipt of a sampling input from the physical system. In certain embodiments, in the method for controlling the operation of a physical system, the physical system is a machine or a plant, such as a MIMO plant for example.

### 1. Model Predictive Control

MPC algorithms are used to calculate optimal control moves, denoted u, required to actuate a system in order to force the system to reach a reference trajectory as efficiently as possible. An MPC block diagram describing a prior art MPC system structure is shown in FIG. 1.

The optimization cost function for MPC is Equ. 1.

$$\begin{matrix}\left({N}_{1} , {N}_{2} , {n}_{u}\right) = E \left({\sum }_{j = {N}_{1}}^{{N}_{2}} δ \left(j\right) {\left[\hat{y} \left(t + j \left|t\right)\right) - w \left(t + j\right)\right]}^{2}\right) \\ \left(+ {\sum }_{j = 1}^{{n}_{u}} λ \left(j\right) {\left[Δ u \left(t + j - 1\right)\right]}^{2}\right)\end{matrix}$$

where N₁ and N₂ are the minimum and maximum cost horizons of the cost function. The optimization of E, the error, also considers, nᵤ is the control horizon, ŷ is the predicted system output and w is the reference signal. The control effort Δᵤ is penalized by the parameter λ, and the predicted error is penalized by δ. For the standard case, a least squares optimization is used to solve Equ. 1. One common MPC methodology is dynamic matrix control (DMC). For one embodiment, DMC is considered for the SP-MPC formulation. In other embodiments, other suitable MPC algorithms such as GPC and their non-linear variants can be used. The DMC algorithm is chosen because it handles model mismatch well and offers a convenient modelling methodology [15].

### A. Dynamic Matrix Control

The DMC algorithm is described by first obtaining a step response to model a controlled system. The standard DMC algorithm assumes a linear time-invariant first order system. A standard linear model expression is a transfer function parametrized with a system gain K and time constant τ as described by Equ. 2.

$$G \left(s\right) = \frac{K}{τ s + 1}$$

The control law is solved using a model in the form of a dynamic matrix A,

$$\text{A=} {\left[\begin{matrix}{a}_{0} & 0 & ⋯ & 0 \\ {a}_{1} & {a}_{0} & ⋯ & 0 \\ ⋮ & ⋮ & ⋱ & ⋮ \\ {a}_{N} & {a}_{N - 1} & ⋯ & {a}_{N - {n}_{u} + 1}\end{matrix}\right]}_{\left(N \times {n}_{u}\right)}$$

where aᵢ is the normalized step responses of the system expressed in relation Equ. 2. At every sampling instant, the model is used to predict the system response N instances into the future, this is known as the prediction horizon N. Optimal control moves are evaluated over a control horizon, nᵤ. In the standard linear case, the values included in A, in Equ.3 do not change.

The prediction ŷ is calculated every |t as,

$$\hat{y} \left(t + k \left|t\right)\right) = {\sum }_{i = 1}^{k} {a}_{i} Δ u \left(t + k - i\right) + {\sum }_{i = k + 1}^{N} {a}_{i} Δ u \left(t + k - i\right) + \hat{n} \left(t + k \left|t\right)\right)$$

where k = 0, 1, 2...N and the first sum denotes the effect of past control moves and the second sum is due to future control actions. Equ. 4 can be rewritten as:

$$\hat{y} \left(t + k \left|t\right)\right) = \hat{y} \left(t + k \left|t - 1\right)\right) + \text{A} Δ u$$

where A is the dynamic matrix as described in Equ. 3. The ŷ is adjusted by a value Ø,

$$\hat{y} = \hat{y} + ϕ$$

where Ø is the difference between the first value of ŷ and the sensor measurement of the plant. This adjustment of the prediction allows the DMC algorithm to mitigate model mismatch in a rudimentary way.

The optimal control move u is calculated using Equ. 3 and Equ. 1. In the unconstrained predictive control algorithm, the result is positive definite and has only one minimum. For this reason, a least square error approach is used and the control law is expressed as,

$$Δ u = {\left({\text{A}}^{T} \text{A+} λ I\right)}^{- 1} {\text{A}}^{T} \left[w \left(t + k \left|t\right)\right) - \hat{y} \left(t + k \left|t\right)\right)\right]$$

where Δu is added to the previous u every sampling instant. A penalty factor λ is required to ensure closed loop stability. This is because the construction of A would otherwise lead to the inversion of an ill-conditioned matrix. More details on the DMC algorithm can be found in [15].

### B. Adaptive MPC

An adaptive version of MPC algorithms is often considered for a system that exhibits non-linear behaviour. The standard practice to implement an adaptive or non-linear MPC controller is to re-valuate the model every closed loop sampling instant tₛ,

$$A = f \left({K}_{{y}_{s}} , {τ}_{{t}_{s}}\right)$$

where plant parameters can be functions of system dynamic or control parameters. For example,

$$K , τ = f \left(u , d x / d t , w\right)$$

This effectively linearizes the system model about the operating point at every tₛ. More information and examples of adaptive DMC can be found in [16].

One important challenge with MPC is the large processing times often required to solve complex models as well as making time varying adjustments to models. It would be beneficial to develop an MPC system and method designed to leverage complex modelling methods while mitigating large control loop processing time.

### 2. Split-Model MPC

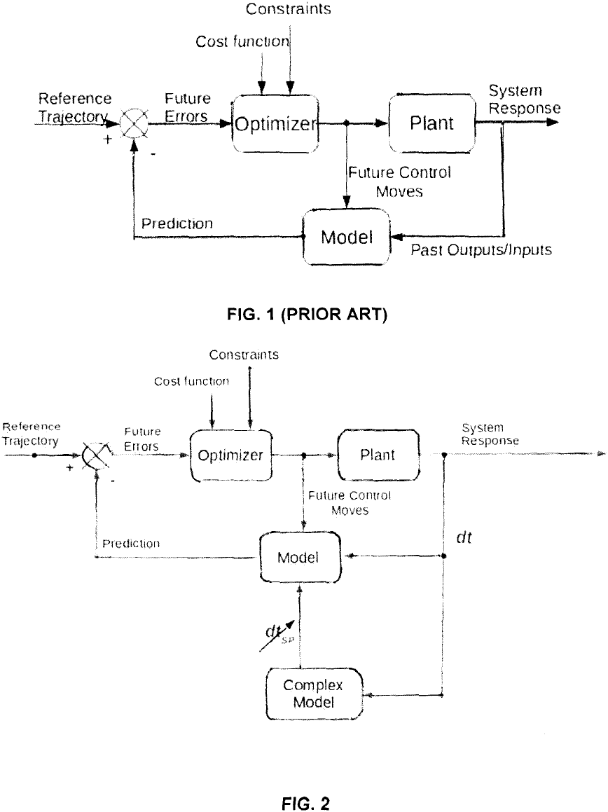

According to one embodiment of the present invention, the algorithm that is developed and tested in simulation here is an SP-MPC control algorithm and is designed specifically for the inclusion of difficult modelling techniques into complex and fast process control. The SP-MPC algorithm is an adaptive MPC algorithm where the model component of the MPC is updated at a different rate than that of the control loop. This allows the non-linear model parameters to be updated on-line based on certain criteria. This is especially powerful if consideration for model parameter selection is based on best possible performance rather than model accuracy. The overall block diagram of the SP-MPC is shown in FIG. 2.

The SP-MPC algorithm is an MPC adaptation where the system model used to calculate ŷ is updating at a frequency other than that of the closed loop sampling rate. The updating [symbol] frequency can be triggered at a consistent rate, with a timer, for example, or the model update can be triggered by an event.

To formulate SP-MPC the general MPC control law is considered:

$$\begin{matrix}\left({N}_{1} , {N}_{2} , {n}_{u}\right) = E \left\{{\sum }_{j = {N}_{1}}^{{N}_{2}} δ \left(j\right) {\left[\hat{y} \left(t + j \left|t\right)\right) - w \left(t + j\right)\right]}^{2}\right) + \\ \left({\sum }_{j = 1}^{{n}_{u}} λ \left(j\right) {\left[Δ u \left(t + j - 1\right)\right]}^{2}\right\}\end{matrix}$$

where N₁ and N₂ are the minimum and maximum cost horizons, Nᵤ is the control horizon, ŷ is the predicted future system output on the considered horizon and w is the desired reference signal. The control effort Δu, is penalized by the parameter λ, and the predicted error is penalized by δ.

The SP-MPC methodology can be readily adapted for different MPC algorithms; in this case it will be adapted for a DMC algorithm. The Dynamic Matrix of a DMC algorithm is expressed as:

$$\text{A=} {\left[\begin{matrix}{a}_{0} & 0 & ⋯ & 0 \\ {a}_{1} & {a}_{0} & ⋯ & 0 \\ ⋮ & ⋮ & ⋱ & ⋮ \\ {a}_{N} & {a}_{N - 1} & ⋯ & {a}_{N - {n}_{u} + 1}\end{matrix}\right]}_{\left(N \times {n}_{u}\right)}$$

The control horizon is nu, the prediction horizon is N and aᵢ are the values from a step test or plant model. m = ƒ(Kₚ,τ). The DMC model A is the same for all time, and can be written as:

$$A = f \left(N , {n}_{u} , m\right)$$

In most non-linear adaptive cases, the model changes every sampling instant and is updated so that:

$$A \left(t\right) = f \left(N , {n}_{u} , m \left(t\right)\right)$$

In the case of SP-MPC, the model of the algorithm is dynamic and changing at a rate or predetermined consequential instant tₛₚ or condition, in other words tₛₚ can be fixed or variable. The new model becomes a function of this secondary sampling rate.

$$A \left({t}_{s p}\right) = f \left(N , {n}_{u} , m \left({t}_{s p}\right)\right)$$

The remainder of the SP-MPC algorithm is similar to the DMC algorithm and is included here for completeness with minor adaptations. The value of Ø is evaluated every sampling instant:

$$ϕ = {y}_{m} \left(t\right) - {\hat{y}}_{t + k \left|t\right)}$$

where k denotes the position in the prediction vector, and at k = 0 the prediction becomes:

$$\hat{y} \left(t + k \left|t\right)\right) = {\sum }_{i = 1}^{k} {a}_{s {p}_{i}} Δ u \left(t + k - i\right) + {\sum }_{i = k + 1}^{N} {a}_{p {s}_{i}} Δ u \left(t + k - i\right) + \hat{n} \left(t + k \left|t\right)\right)$$

The values of aₛₚᵢ are values obtained from the updated model. Equation 5.7 can be rewritten with the updated model as:

$$\hat{y} \left(t + k \left|t\right)\right) - \hat{y} \left(t + k \left|t - 1\right)\right) + {\text{A}}_{{\text{t}}_{\text{s}} \text{P}} Δ u$$

The optimal control move is found by introducing Equ. 17 into Equ. 18

$$Δ u = {\left({\text{A}}_{{\text{t}}_{\text{s}} \text{P}} {}^{T} {\text{A}}_{\text{t} {}_{\text{s}} \text{P}} + λ I\right)}^{- 1} {\text{A}}_{{\text{t}}_{\text{s}} \text{P}} {}^{T} \left[w \left(t + k \left|t\right)\right) - \hat{y} \left(t + k \left|t\right)\right)\right]$$

The present invention, in another embodiment, relates to a multiple-input and multiple-output (“MIMO”) formulation for SP-MPC, as well as the integration of SP-MPC methodology into other MPC algorithms which follows as above.

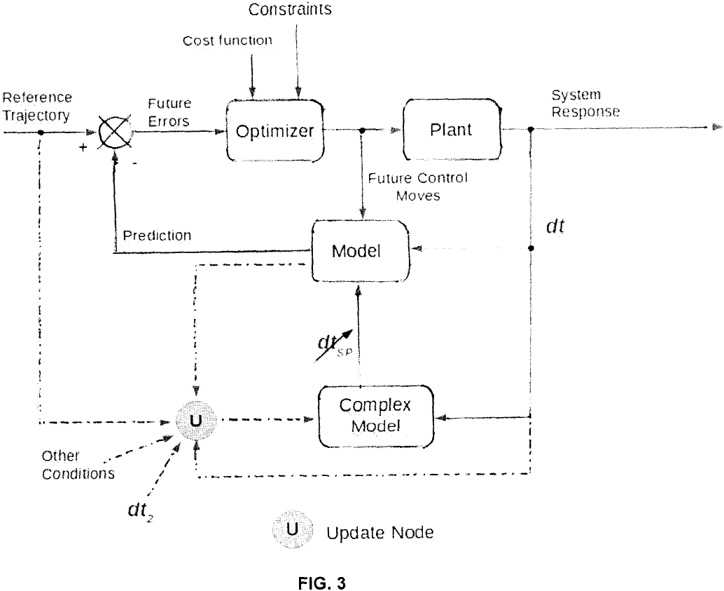

A Split Model MPC according to another embodiment of the present invention is depicted in FIG. 3. An update node “U” is shown. The update node U is the trigger required to update the Model. The update node U is activated by dt₂as shown in FIG. 3. For example, dt₂ is the injection speed, which was used as the update condition in the simulation with an injection molding machine (see below). The reference trajectory can also be used as the update condition. For example, the reference trajectory was used as the update condition in the simulations with a vertical robot manipulator and a Bead-on-Hoop (see below).

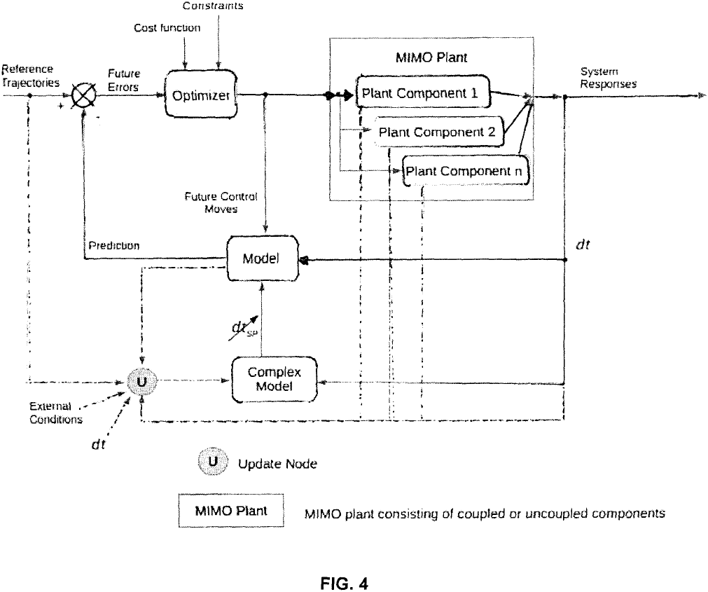

A MIMO Split Model MPC according to another embodiment of the present invention is depicted in FIG. 4. In the MIMO embodiment of the Split Model-MPC, there is an update condition for the complex model. The update condition of the complex model can be a state or set of states of the individual plant components as well as a timed interval. In the case of a multiple degree of freedom robot manipulator, for example, an angle, speed or torque of a joint or link could be used to trigger a model update. This means that the control structure can handle components with different time varying dynamics. For example, in a multiple degree of freedom vertical robot manipulator case (see below) if any two adjacent angles are equal to each other, the robot manipulator is operating in a difficult control region and the complex model can be leveraged to mitigate expected control problems at that time.

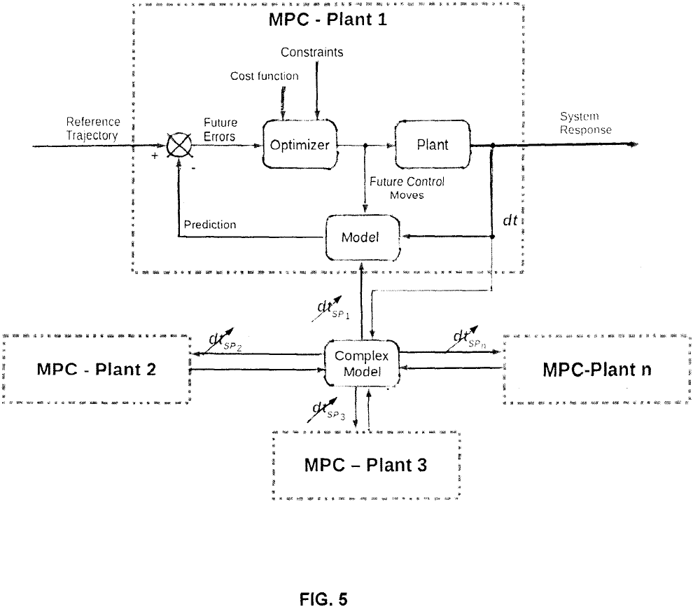

A Split Model MPC configuration for a process with multiple plants according to another embodiment of the present invention that extends the present invention to a multi-plant is depicted in FIG. 5. In the multi-plant extension of the Split Model-MPC, there are different update conditions driven by a central complex model. The update conditions of the complex model can be a state or set of states of the individual plant components as well as a timed interval.

### 3. Simulation Models

Simulation models of a Bead-on-Hoop (BoH) and vertical robot manipulator are presented to give insight into these, which are used in the development and testing of the new MPC adaption, Split Model MPC (SP-MPC). These models are selected because they respond relatively quickly to control actions and disturbances and are non-linear with challenging dynamic behaviours. SP-MPC was also tested with injection speed data produced with an injection molding machine (“IMM”).

When using AI schemes, it is important to understand the equipment and models that are being used. It is necessary to develop an intuition as to how the AI algorithms work, as well as the equipment and model dynamics. AI schemes are very much like complex calculators, a designer must be comfortable with their choice to trust the solutions that an AI structure provides. For this reason, the dynamic responses of the simulated systems are discussed here.

### Bead-On-Hoop System

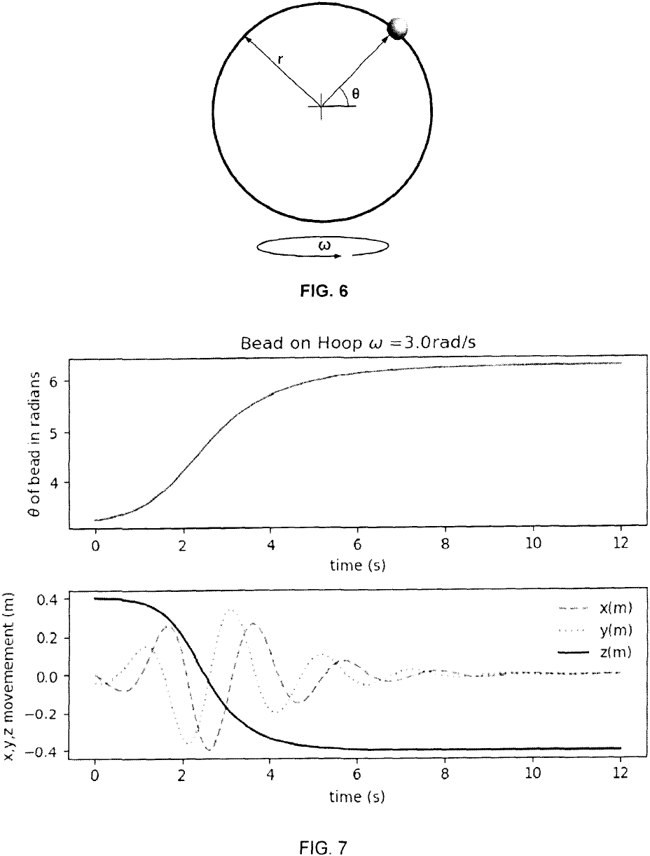

The BoH model shown in FIG. 6 is an interesting SISO model that has significant level of non-linearity as the centrifugal forces on the bead are the main driver for the height of the bead on the hoop. The height of the bead is the variable that will be controlled. Required control moves are dependent on the position and velocity states of the bead.

The BoH dynamics are represented by Equ.19, Equ. 20a, and Equ. 20b

$$\ddot{θ} - {w}^{2} s i n θ c o s θ + \frac{g}{R} s i n \left(θ\right) + \frac{b}{m} \dot{θ} = 0$$

which can be rewritten in state-space as;

$$w = \dot{θ}$$

$$\dot{ω} = {ω}^{2} s i n θ c o s θ - \frac{g}{R} s i n \left(θ\right) - \frac{b}{m} \dot{θ}$$

where R is the radius of the circle, g is gravity and θ is the angle as demonstrated in FIG. 6.

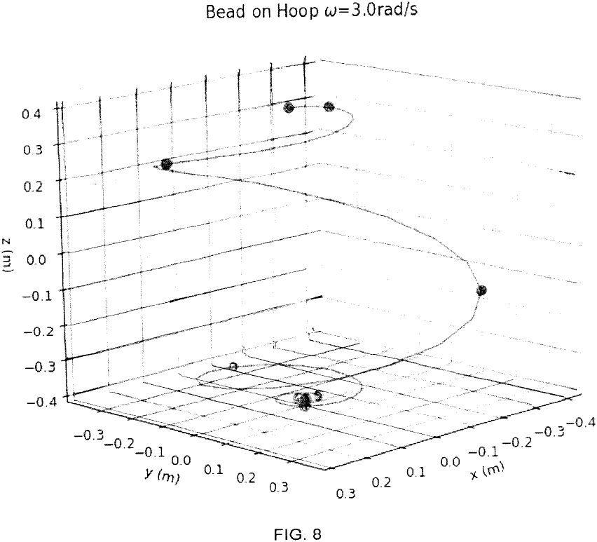

The following three examples are meant to help show the dynamics of the model. The first consideration is that the hoop must be rotating at a speed that allows the centrifugal forces on the bead to overcome gravity forces on the bead, otherwise it will simply fall to the bottom of the hoop in FIG. 7 and FIG. 8.

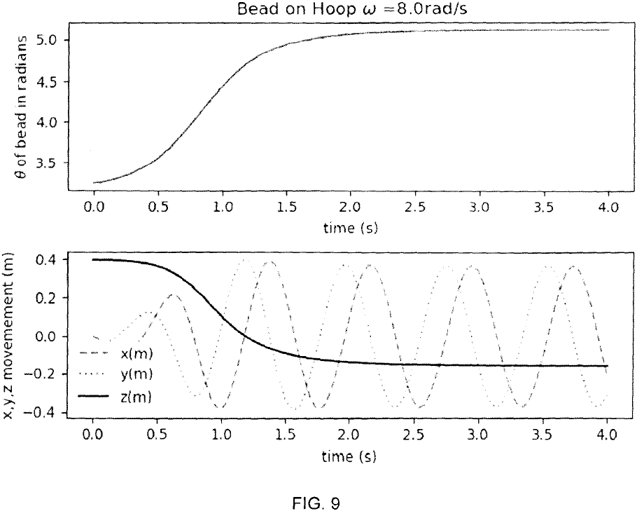

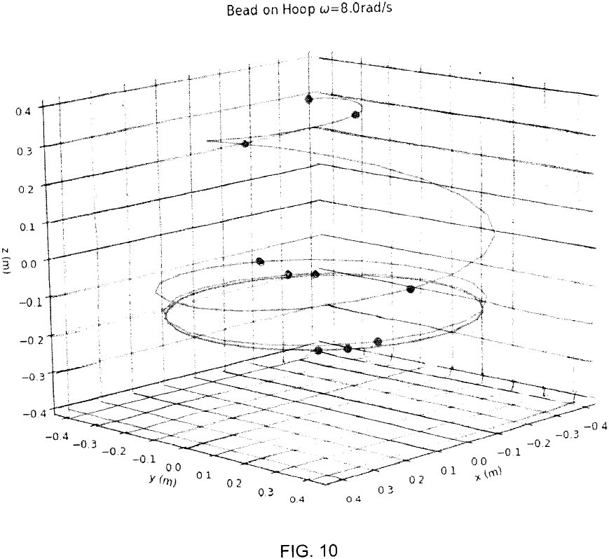

Next is a scenario where the rotation of the hoop allows the centrifugal forces in the bead to be greater than gravity and the bead can climb the hoop in FIG. 9 and FIG. 10.

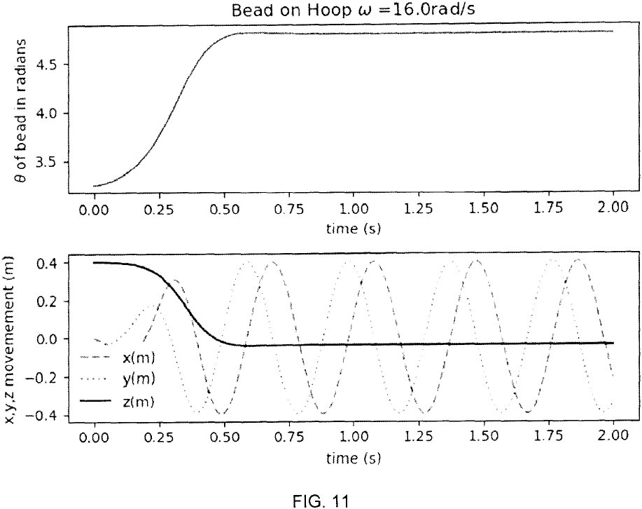

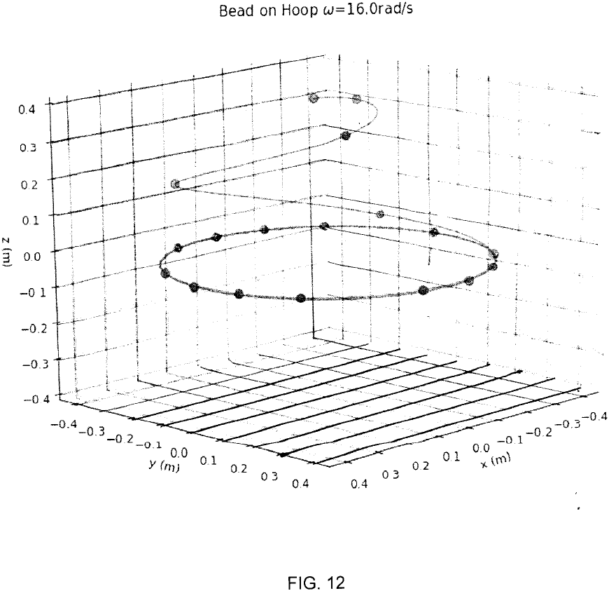

In the final scenario, the centrifugal forces push the bead outwards to the equator of the rotating hoop, at which point increasing the ω results in no increased upward motion of the bead in FIG. 11 and FIG. 12.

TABLE 1

Bead Rotating Hoop Parameters

| Parameter | Value | Units |
|---|---|---|
| b | 50 | Ns/m |
| m | 2 | kg |
| r | 0.4 | m |
| g | 9.81 | $\frac{m}{{s}^{2}}$ |

### Two Link Vertical Manipulator

The two link vertical robot model is based off of a manipulator that was constructed by a senior design project for the Intelligent Controls Laboratory at The University of New Brunswick. Examples of control implementations on the actual manipulator can be found in [16] and more information on the derivation of the dynamic model can be found in [17].

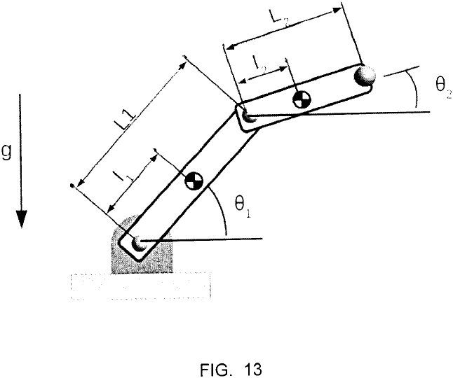

From FIG. 13 the following derivation for equations (Equ.21 - Equ.31) of motion are made based on potentiality and kinetic energies, where kinetic energy equation is:

$$\begin{matrix}E = \frac{1}{2} \left(M 1 + M 2\right) {L}_{1}^{2} {\dot{θ}}_{1}^{2} + \frac{1}{2} {M}_{2} {L}_{2}^{2} {\dot{θ}}_{2}^{1} + {M}_{2} {L}_{2}^{2} {\dot{θ}}_{1} {\dot{θ}}_{2} + \\ \frac{1}{2} {M}_{2} {L}_{2}^{2} {θ}_{2}^{2} + {M}_{2} {L}_{1} {L}_{2} \left({\dot{θ}}_{1} {\dot{θ}}_{2} {\dot{θ}}_{1}^{2}\right) c o s \left({θ}_{1}\right)\end{matrix}$$

The potential energy of the links is:

$$U = {M}_{1} g {L}_{1} c o s \left({θ}_{1}\right) + {M}_{2} g \left({L}_{1} c o s \left({θ}_{1}\right) + {L}_{2} c o s \left({θ}_{1} + {θ}_{2}\right)\right)$$

Considering the partial derivative of the Lagrangian, L = E-U, the equation of motion with the torque τ that drive the links:

$$τ = \frac{d}{d t} \left(\frac{δ L}{δ {\dot{θ}}_{i}}\right) - \left(\frac{δ L}{δ {\dot{θ}}_{i}}\right)$$

The derivation with the addition of a term accounting for belt and bearing friction yields:

$$\text{M} \left(θ\right) \ddot{Θ} + \text{C} \left(θ , \dot{θ}\right) + \text{G} \left(θ\right) + \text{B} \left(θ\right) = τ$$

Where the torques generated by the motors, τ are:

$$τ = \left[\begin{matrix}{V}_{f 1} {υ}_{1} \\ {V}_{f 2} {υ}_{2}\end{matrix}\right]$$

and, M(θ) is:

$$\text{M=} \frac{1}{12} \left[\begin{matrix}M 1 & M 2 \\ M 3 & M 4\end{matrix}\right]$$

where:

$$M 1 = 2 {m}_{2} {l}_{1} {\overline{x}}_{2} cos {Θ}_{2} + {M}_{2} {l}_{1}^{2} + {m}_{2} {\overline{x}}_{1}^{2} + {m}_{2} {\overline{x}}_{2}^{2} + {I}_{t o t 1} + {I}_{t o t 2}$$

$$M 2 = {m}_{2} {l}_{1} {\overline{x}}_{2} cos {Θ}_{2} + {m}_{2} {\overline{x}}_{2}^{2} + {I}_{t o t 2}$$

$$M 3 = {m}_{2} {l}_{1} {\overline{x}}_{2} cos {Θ}_{2} + {m}_{2} {\overline{x}}_{2}^{2} + {I}_{t o t 2}$$

$$M 4 = {m}_{2} {\overline{x}}_{2}^{2} + {I}_{t o t 2}$$

and the Coriolis forces generated in the spinning links, C are:

$$\text{C =} \frac{1}{12} \left[- {m}_{2} : sin {Θ}_{2} {\dot{Θ}}_{2}^{2} - 2 {m}_{2} {l}_{1} {\overline{x}}_{2} {m}_{2} {l}_{1} {\overline{x}}_{2} sin {Θ}_{2} {\dot{Θ}}_{1}^{2}\right]$$

and B is

$$\text{B=} \left[\begin{matrix}{β}_{1} {\dot{Θ}}_{1} \\ {β}_{2} {\dot{Θ}}_{2}\end{matrix}\right]$$

and G is:

$$\text{G=} \frac{g}{12} \left[\begin{matrix}{m}_{2} {l}_{1} sin {Θ}_{1} + {m}_{1} {\overline{x}}_{1} sin {Θ}_{1} + {m}_{2} {\overline{x}}_{2} \left({Θ}_{1} + {Θ}_{2}\right) \\ {m}_{2} {\overline{x}}_{2} sin \left({Θ}_{1} + {Θ}_{2}\right)\end{matrix}\right]$$

Rearranging Equ. 24 for Θ̈ results in the state space formulation used to generate the simulations presented here.

$$\ddot{Θ} = {\text{M}}^{- 1} \left(τ - \text{C} - \text{B} - \text{G}\right)$$

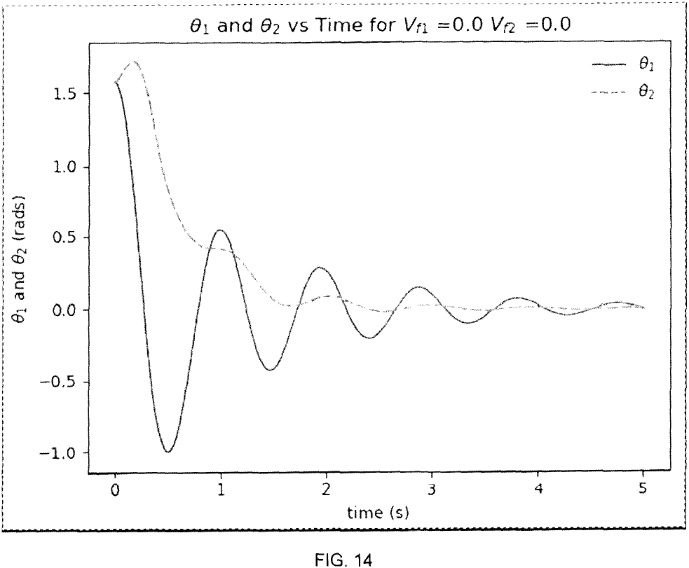

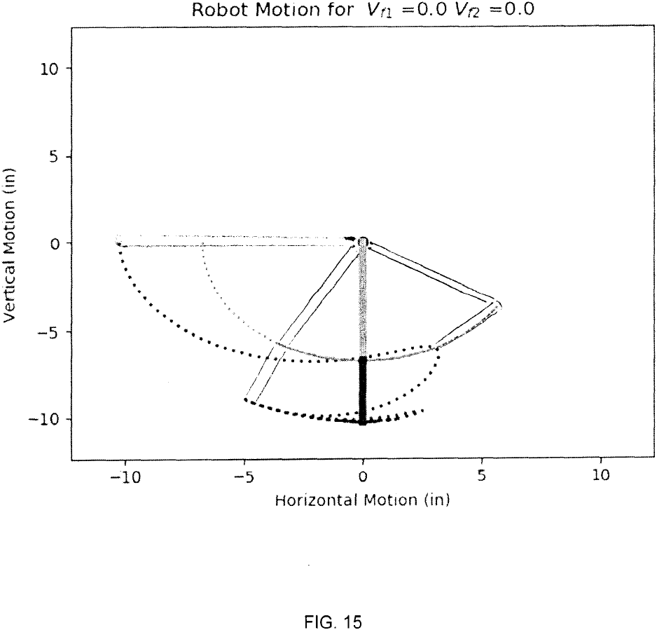

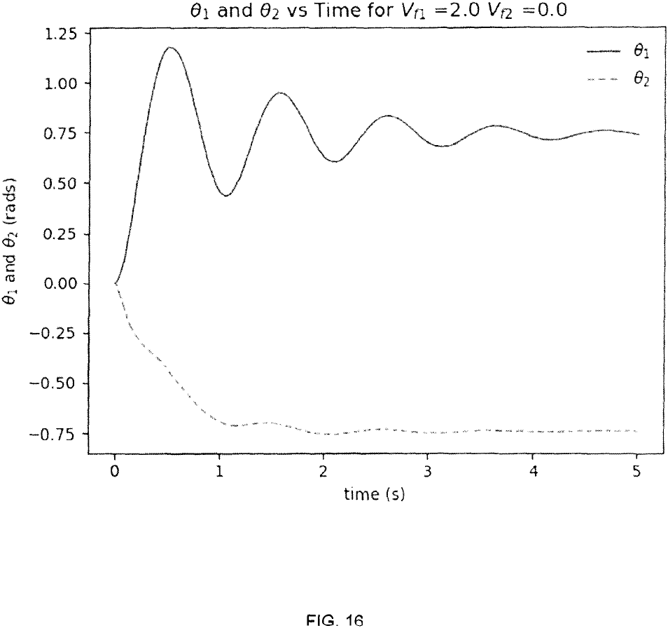

The following figures are examples of the robot operating in open loop fashion. FIG. 14 and FIG. 15 show the free response of the robot manipulator starting from a completely horizontal position.

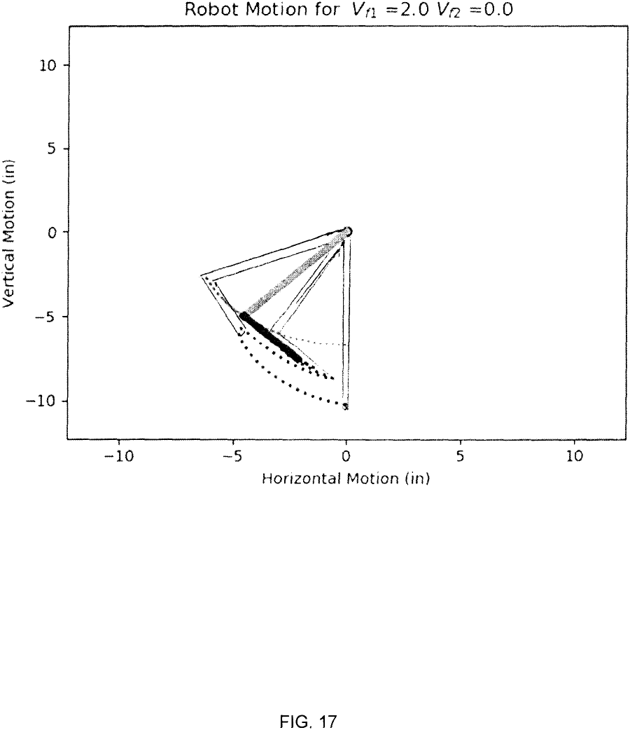

In FIG. 16 and FIG. 17, the actuation voltage is only applied to the first motor to rotate link one. There is a large damping factor between links one and two. This is expressed in the response of the manipulator as link two does not return to a vertical position.

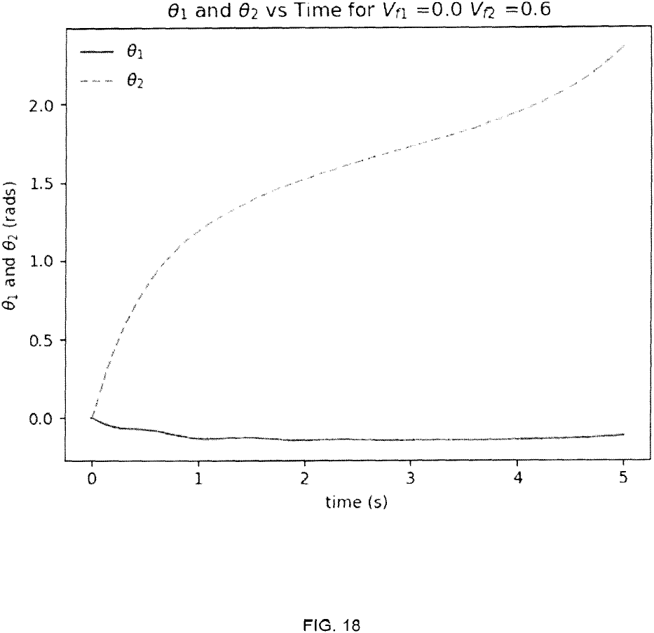

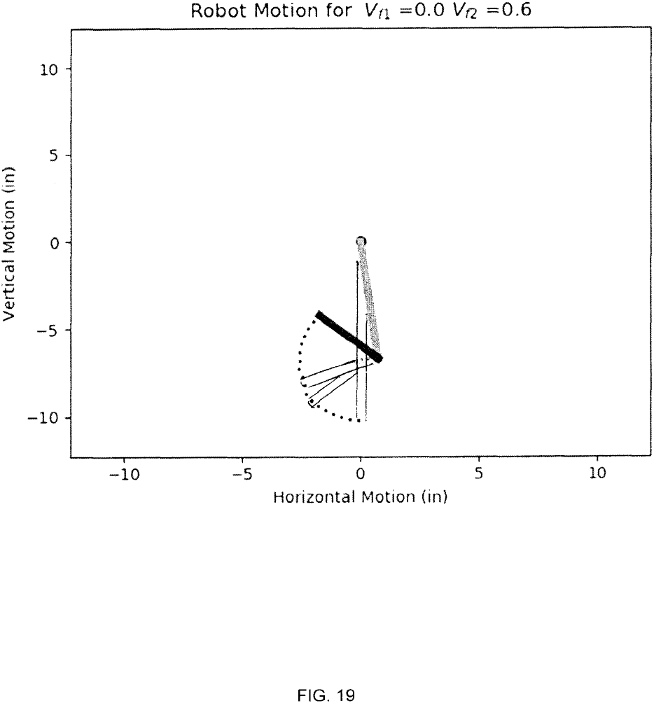

In FIG. 18 and FIG. 19, the actuating voltage is only applied to the second motor to rotate the second link. In this case, the variables of the link masses allow the inertia of the second link to affect the first. The mass of the first link is larger than the second mass; this mitigates the effect of the damping between links one and two.

TABLE 2

Vertical Link Manipulator Parameters [16]

| Parameter | Value | Units |
|---|---|---|
| m1 | 0.43913 | kg |
| m2 | 0.14608 | kg |
| link1 | 0.171 | m |
| link2 | 0.089 | m |
| xbar1 | 0.053129 | m |
| xbar2 | 0.037546 | m |
| I1 | 0.0030449 | kg m² |
| I2 | 0.0007843 | kg m² |
| b1 | 0.02260 | N m s |
| b2 | 0.03390 | N m s |
| τ1 | 0.1378 | N m/V |
| τ2 | 0.1345 | N m/V |
| Gravitational constant | 9.81 | m/s² |

### 4. Results

### SP-MPC Bead-On-Hoop Simulation Results

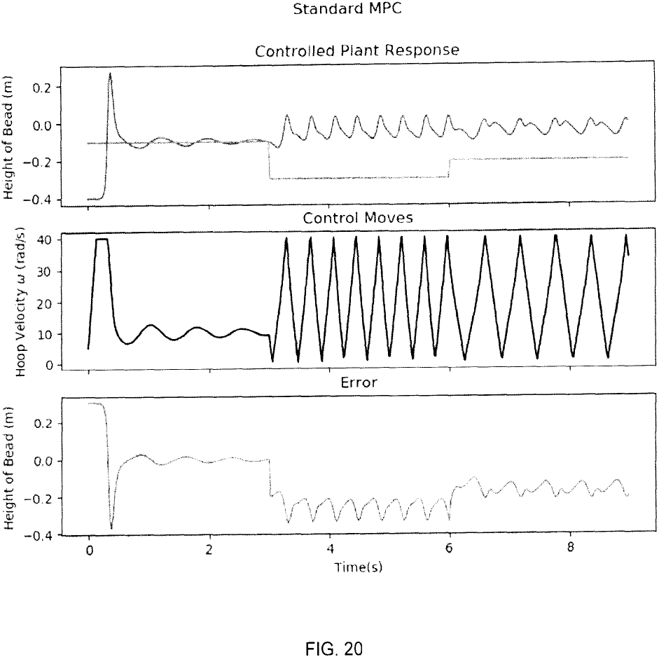

The following results are obtained from the simulated control of the BoH model. This model has challenging dynamics for the MPC algorithm to achieve good control. In FIG. 20, a standard MPC approach is used to control the height of the BoH. The DMC control algorithm is having difficulty with the task, which is expected because the plant dynamic response is nonlinear and the standard DMC approach does not account for these changes. In this case, the model mismatch from one state to another is too challenging for the algorithm.

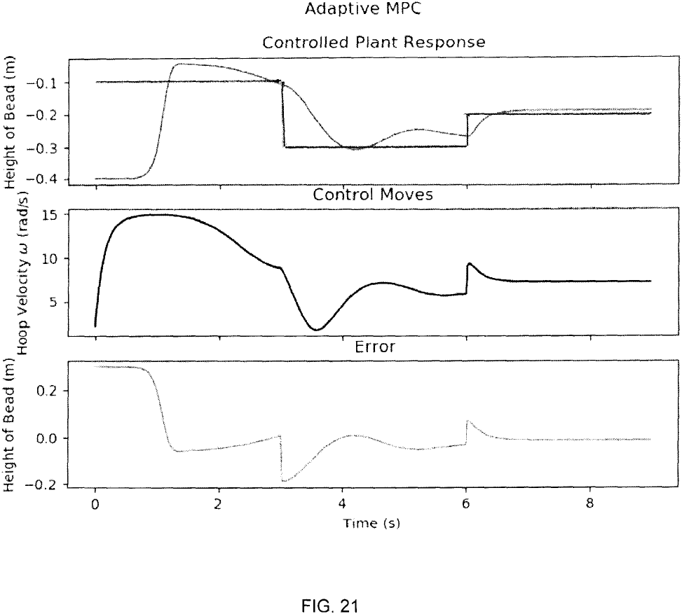

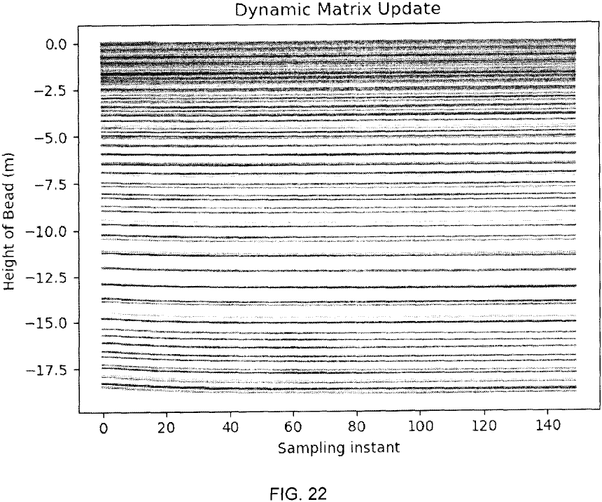

An adaptive scheme, such as the one presented in FIG. 21, allows for closer control but still struggles to reach set points quickly. The model used to calculate the optimal u is updated every sampling instant. The open loop responses used to create the A are shown in FIG. 22.

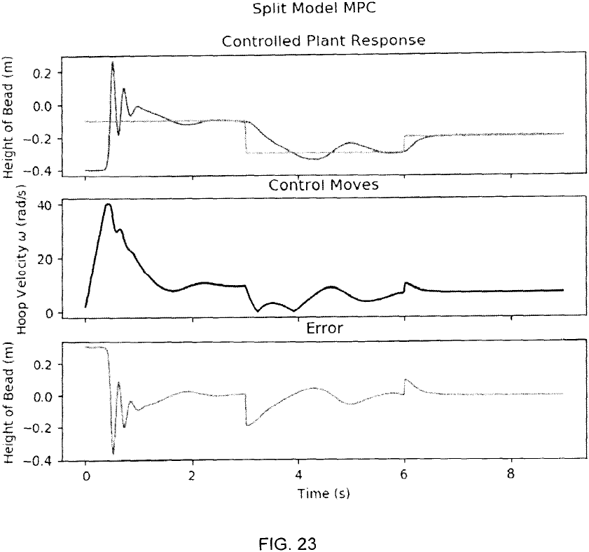

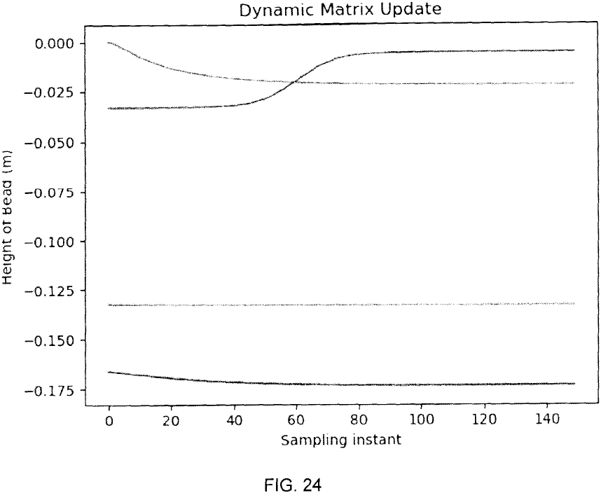

The SP-MPC performs better than the adaptive algorithm because it only adapts the model at setpoint changes as shown in FIG. 23. The advantage is that the model adaptation is made for optimal performance. The matrix A is evaluated only three times during the algorithm and once beforehand. The open loop responses are shown in FIG. 24

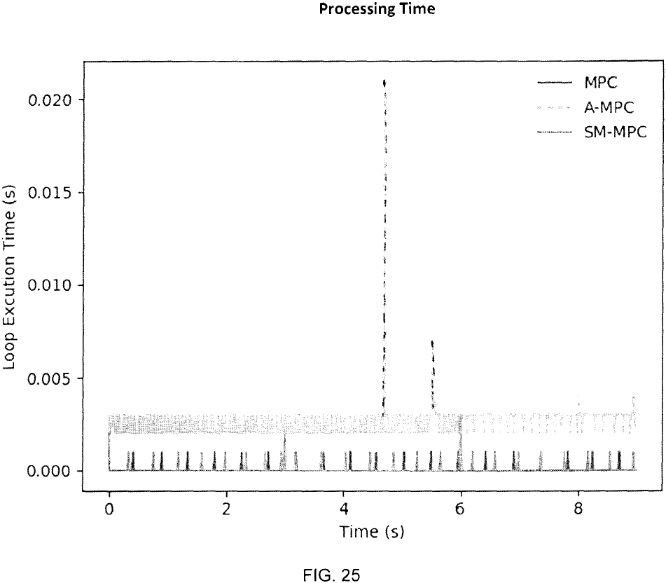

Also, the processing time required to operate the closed loop controlled plant is greatly mitigated as shown in FIG. 25.

When considering the SP-MPC structure, it becomes possible to use more complex modelling methodologies to better predict and optimize control moves. This is with respect to modelling methodologies that have high processing time requirements.

### SP-MPC Injection Molding Results

In order to practically demonstrate the advantages of using a SP-MPC format for system automation, an injection speed control on the IMM was considered. The injection speed of the plastic into the mold is important as it affects the end quality of the part being produced. To achieve this, a voltage signal (u) is used to actuate a hydraulic control valve that allows flow of hydraulic fluid and pushes a ram forward which in turn pushes plastic into a mold. The injection speed of the polymer into the mold is described as a first order system.

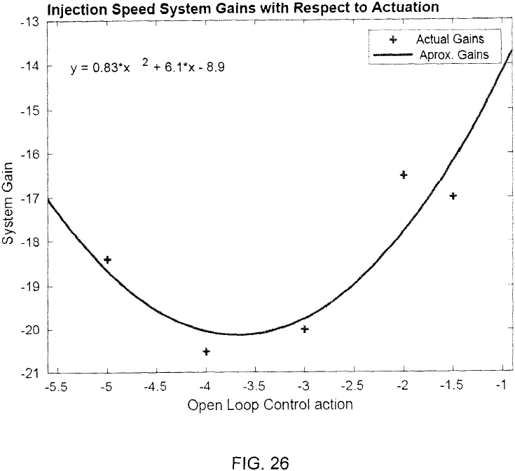

A number of open loop tests were conducted on an IMM, and process parameters were extracted from the experimental results. It was determined that τ = 0.08 seconds and that the system gain, K was a function of u applied to the system as shown in FIG. 26.

A quadratic equation was used to approximate the system K in the results presented here. The injection speed process was selected to demonstrate the SP-MPC because of the non-linearity and its fast nature. The non-linearities of the system require an adaptive control methodology for proper closed loop control, while the fast nature of the system requires the adaptation to be simplified for improved processing time.

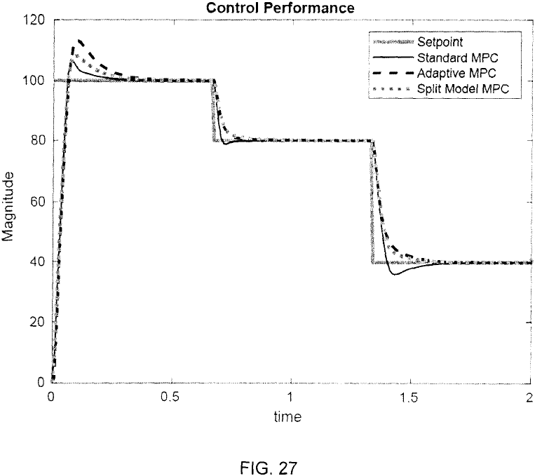

Standard MPC, Adaptive MPC and SP-MPC results are compared here in simulation. All of the control parameters and plant initial conditions were identical. The only difference between the three controllers is the update rate of the model. In the case of the standard MPC, the system model is not updated and the system is assumed linear. The Adaptive MPC updates the system model every sampling instant and the SP-MPC updates the system model every 0.1 seconds. The sampling rate of the control algorithm is 0.01 seconds. The control performance can be seen in FIG. 27.

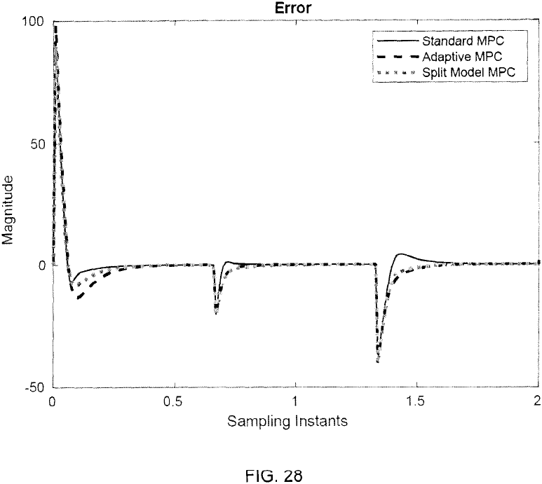

From the control response, it can be seen that all controllers result in overshoot on the first setpoint; this is a result of the initial large error and consequent large control moves. The overshoot of the standard MPC is the least; this is because the initial model for all controllers was evaluated with an assumed initial u = -2.0. The overshoot of the standard MPC is larger in subsequent setpoints; this is because of model mismatch. All controllers achieve the setpoint eventually because of the Ø term in the DMC formulation. The discussed behaviour is more legible when looking at the error in FIG. 28.

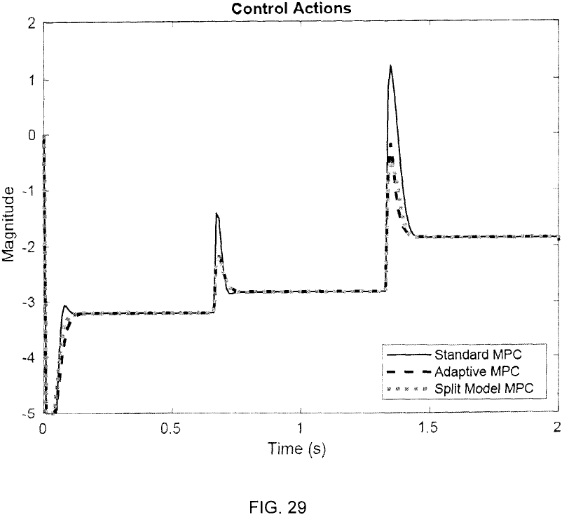

As expected, the overall error of the standard MPC is larger than that of the adaptive MPC and the SP-MPC. The adaptive MPC and SP-MPC have comparable control performance. Particularly, SP-MPC formulation resulted in less aggressive control action calculations, as seen in FIG. 29. This is likely because the model is adapted for the system operating conditions at any given time, but stagnate within the nᵤ.

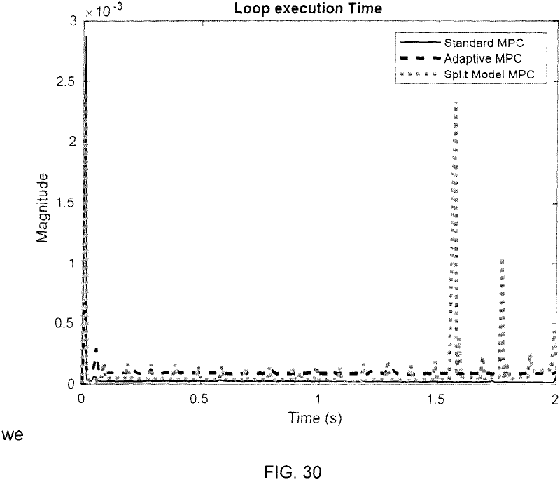

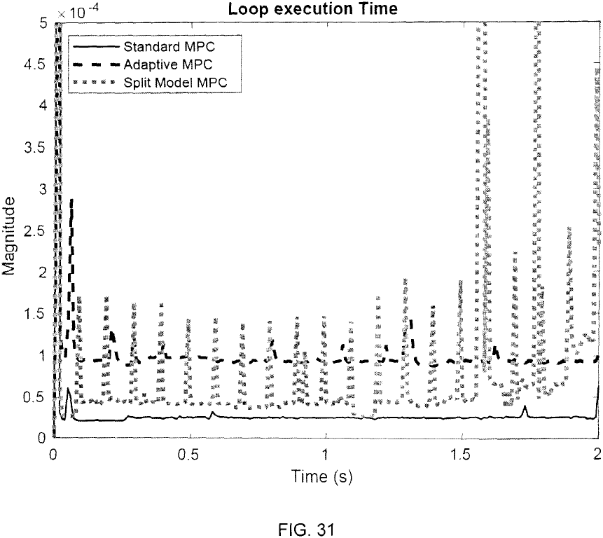

The main focus of the SP-MPC proposition is to provide an MPC control solution for complex plants that allow for complex model processing time. To this end, the loop execution time of the three control algorithms was measured during simulations. The DMC control law requires a matrix inversion; this is computationally expensive enough to appear in the control loop processing time measurement. Matlab software was used to simulate the control of injection speed here. In FIG. 30, an initial spike can be seen in the first loop; this is the first time evaluation of the dynamic matrix. Afterwards, spikes can be seen for the SP-MPC, as the model is updated. A close up the this can be seen in FIG. 31.

The cycle processing time for the Adaptive MPC is consistently larger than the cycle processing time for the other controllers. Even though it has significantly improved performance over the standard MPC, if more complex models were used it may not be a viable control methodology. There are a number of modelling methods that are more computationally intensive than a dynamic matrix. The SP-MPC presented comparable control performance and has smaller overall loop cycle time processing times. What is most important to consider with SP-MPC is that its structure lends itself well to parallel processing implementations of the model updates.

### SP-MPC MIMO Robot Manipulator Simulation

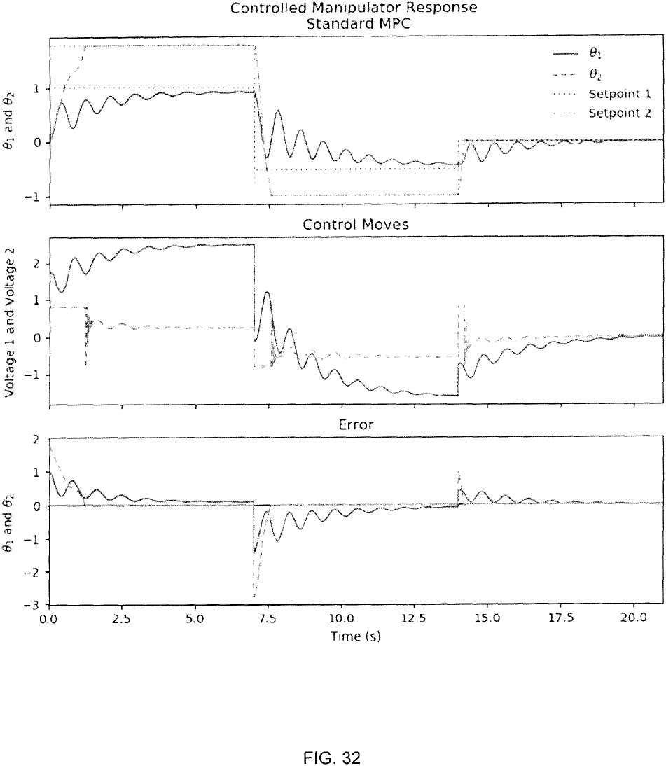

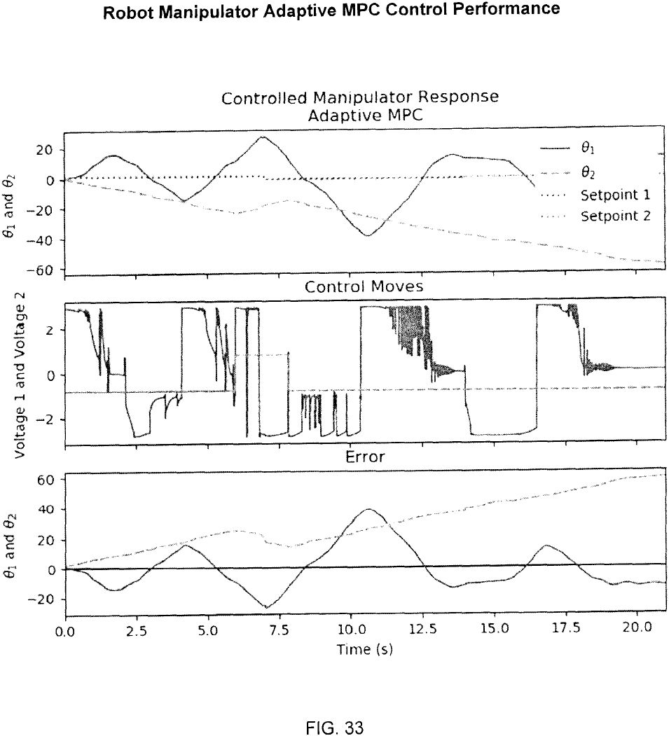

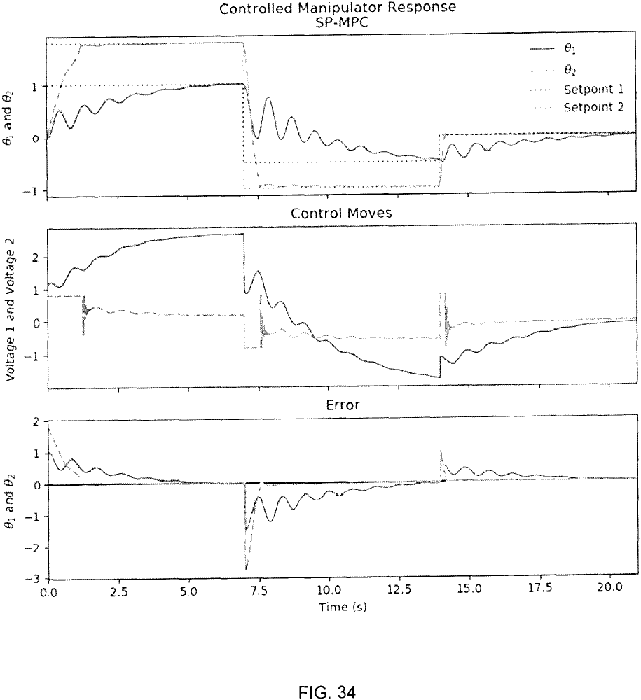

For completeness, an example of a non-linear MIMO system is included. The following results are from the two link vertical robot manipulator. The results of a standard MPC, Adaptive MPC and SP-MPC are shown in FIG. 32, FIG. 33 and FIG. 34.

Because the manipulator is subjected to rapid changes in setpoints, the second order dynamics on the first link caused by the strong coupling of the second joint are apparent in the controller response. This could be mitigated using ramp setpoints, but this work aims to show how model adjustment can be leveraged to improve closed loop control.

In the standard MPC example, favourable initial conditions and actuation variables were used to construct the dynamic matrix of the DMC algorithm. In the case of the adaptive MPC algorithm, the dynamic matrix was updated to better match the expected dynamics of the manipulator with poor results seen in FIG. 33.

It might be expected that a more accurate model would result in better control, and often that is the case. The manipulator model requires a matrix inversion in its solution and under certain circumstances an ill conditioned matrix arises resulting in the above closed loop response. The SP-MPC control simulations shows improved closed loop control. The model is adjusted for the setpoints to provide improved control. The system gain, Kₚ, is halved and initial conditions of the manipulator are chosen to construct the dynamic matrix. The reduction of the gain forces causes the plant to under-actuate and mitigates the second order dynamics that would otherwise be amplified by the first order DMC substructure.

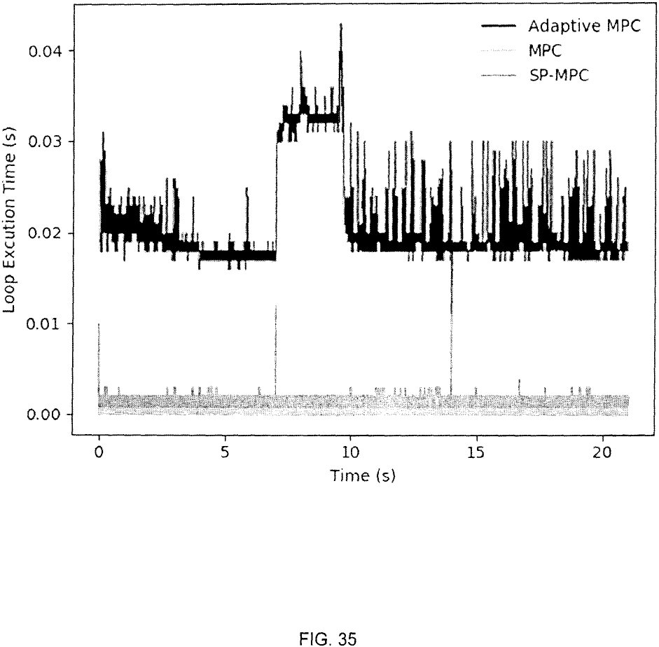

Again, the processing requirements for the SP-MPC are significantly reduced when compared to the adaptive MPC algorithm, as shown in FIG. 35.

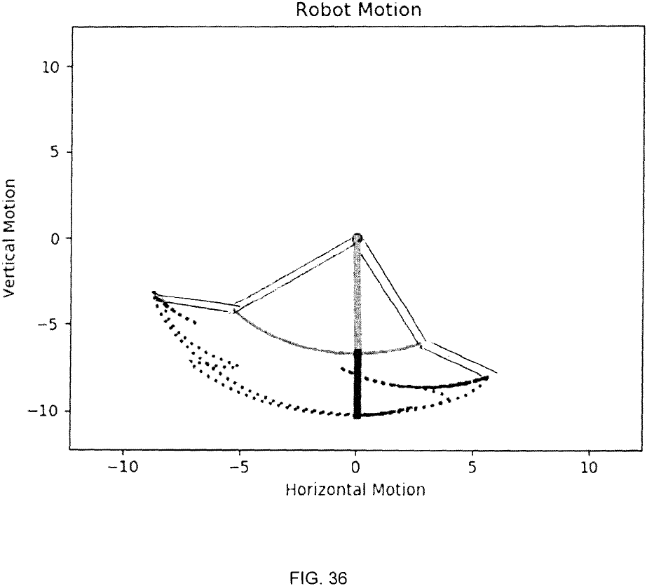

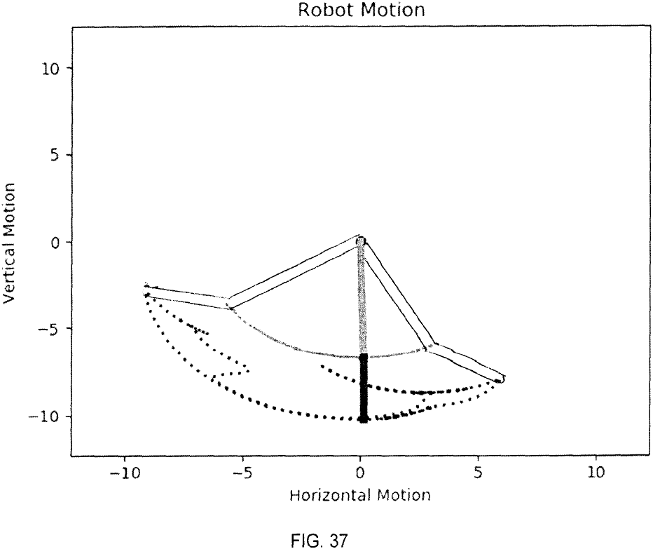

The comparisons of the robot motion are shown in FIG. 36 for standard MPC and in FIG. 37 for the adaptive schemes.

In one embodiment, the present invention relates to a method for controlling a system controlled by a model predictive controller, the controller including a predictive model of the system and a complex model; updating the prediction model using the complex model; measuring a difference between the prediction model output and a complex reference trajectory; calculating a correction parameter based on the measured difference to adjust the prediction model output for the system and controlling the system using the adjusted prediction model output. In certain embodiments of the present invention, the complex model can be selected from the group consisting of a machine learning method (for example a neural network), a time-consuming modeling method other than a machine learning method, and a leverage model. In certain embodiments, the system is a plant or a machine.

In another embodiment, the present invention relates to a device for controlling a system including a model predictive control unit including a memory for storing at least instructions and a processor device that executes the instructions to enable actions including: generating a prediction model and a complex model; updating the prediction model using the complex model; measuring a difference between the prediction model and a reference trajectory; calculating a correction parameter based on the measured difference; applying the correction parameter to the prediction model output to adjust the prediction model output. In certain embodiments of the present invention, the prediction model can be updated at a pre-set interval, or when a specified update condition occurs. In certain embodiments of the present invention, the complex model can be selected from the group consisting of a machine learning method (for example a neural network), a time-consuming modeling method other than a machine learning method, and a leverage model. In certain embodiments, the system is a plant or a machine.

Although the invention has been described with reference to the specific exemplary embodiments intended to instruct and illustrate the invention, the disclosed SP-MPC controller and technique is not limited to those embodiments. Various modifications, improvements and additions may be implemented by those with skill in the art, and such modifications, improvements, and additions will not depart from the scope of the invention.

Also, those skilled in the art will understand that the partitioning of individual components of the SP-MPC controller system blocks and controller units as described herein is discretionary to those responsible for controller implementation and operation. It will be understood that all of these functions can be implemented in any desired manner on any desired device(s). Moreover, while the SP-MPC controller technique described herein is preferably implemented in software, it or any portions thereof may be implemented in hardware, firmware, etc., and may be implemented by any other processor associated with a process control system. Thus, the elements described herein may be implemented in a standard multi-purpose CPU or on specifically designed hardware or firmware such as an application-specific integrated circuit (ASIC) or other hard-wired device as desired. When implemented in software, the software routine may be stored in any computer readable memory such as on a magnetic disk, a laser disk (such as a CD, a DVD, etc.), a flash drive or other storage medium, in a RAM or ROM of a computer or processor, in any database, etc. Likewise, this software may be delivered to a user or a plant such as a process plant via any known or desired delivery method including, for example, on a computer readable disk, a smart card memory, a flash drive, or other transportable computer storage mechanism or over a communication channel such as a telephone line, the internet, etc. (which are viewed as being the same as or interchangeable with providing such software via a transportable storage medium).

Moreover, the claims provided herein are properly construed to embrace all modifications, variations and improvements that fall within the true spirit and scope of the invention, as well as substantial equivalents thereof. Accordingly, other embodiments of the invention, although not described with particularly herein, are none-the-less comprehended within the scope of the invention.

### REFERENCES

F. Pérez, E. Irisarri, D. Orive, M. Marcos, and E. Estevez, “A CPPS Architecture approach for Industry 4.0”, 2015 IEEE 20th Conference on Emerging Technologies Factory Automation (ETFA), 2015, pp.1-4

J. Lee, B. Bagheri, H. Kao, “A Cyber - Physical Systems architecture for Industry 4.0-based manufacturing systems”, Manufacturing Letters, vol.3, 2015, pp. 18 -23

S.Thiede, M. Juraschek, C. Herrmann, “Implementing Cyber -physical Production Systems in Learning Factories”, 6th CIRP Conference on Learning Factories, vol. 54, 2016, pp. 7-12

L. Stojanovic, M. Dinic, N. Stojanovic, A. Stojadinovic, “Big-data-driven anomaly detection in industry 4.0: An approach and a case study”, 2016 IEEE International Conference on Big Data, 2016, pp.1647-1652

J. Schlechtendahl, M.Keinert, F. Kretschmer, A. Lechler, A. Verl, “Making existing production systems Industry 4.0-ready”, vol. 9, no.1, Production Engineering, 2015, pp. 143 -148

D.Q. Mayne, J. B. Rawlings, C.V. Rao, P.O.M. Scokaert, “Constrained model predictive control: Stability and optimality”, vol. 36, no. 6, Automatica, 2000, pp. 789-814

R. Finn and R. Dubay, “Nonlinear Gain Approximation Structure using Manifold Learning on a Vertical Manipulator”, IEEE Intelligent Systems, vol. 34 (4), 2019, Early Access Content

L. McCurlie, M. Preindl, A. Emadi, “Fast Model Predictive Control for Redistributive Lithium - Ion Battery Balancing”, IEEE Transactions on Industrial Electronics, vol. 64, no.2, 2017, pp.1350-1357

Kamel, M. and Alexis, K. and Achtelik, M. and Siegwart, R. “Fast nonlinear model predictive control for multicopter attitude tracking on SO (3)”, 2015 IEEE Conference on Control Applications (CCA), 2015, pp. 1160-1166

M. Neunert, C. Crousaz, F. Furrer, M. Kamel, F. Farshidian, R. Siegwart, J. Buchli,” Fast nonlinear Model Predictive Control for unified trajectory optimization and tracking”, 2016 IEEE International Conference on Robotics and Automation (ICRA), 2016, pp.1398 -1404

Z. Mynar, L. Vesely, P. Vaclavek, “PMSM Model Predictive Control With Field -Weakening Implementation”, IEEE Transactions on Industrial Electronics, vol.63, no.8, 2016, pp. 5156 -5166.

E. Kayacan, H. Ramon, W. Saeys, “Robust Trajectory Tracking Error Model -Based Predictive Control for Unmanned Ground Vehicles”, vol. 21, no. 2, 2016, pp. 806-814

M. Kamel, T. Stastny, K. Alexis, R. Siegwart, Roland, “Model Predictive Control for Trajectory Tracking of Unmanned Aerial Vehicles Using Robot Operating System, Robot Operating System (ROS): The Complete Reference”, (vol. 2), Springer International Publishing, Koubaa, Anis, 2017, pp. 3-39

Camponogara, D. Jia, B. H. Krogh, S. Talukdar, “Distributed model predictive control”, vol. 22. IEEE Control Systems Magazine 2002, pp. 44-52

C.R. Cutler, B.L. Ramaker, “Dynamic matrix control. A computer control algorithm.”, In joint automatic control conference, No. 17, 1980, pp. 72

J. Wilson M. Charest, R. Dubay, “Non-linear model predictive control schemes with application on a 2 link vertical robot manipulator”, Robotics and Computer-Integrated Manufacturing, vol. 41, 2016, pp. 23-30

M. Charest, R. Finn, R. Dubay, “Integration of artificial intelligence in an injection molding process for on-line process parameter adjustment”, 2018 Annual IEEE International Systems Conference (SysCon), 2018, p. 1-6

We claim:

1. A model predictive control system for controlling the operation of a physical system comprising:
at least one non-transitory memory operable to store program code;
a model predictive control (MPC) controller including at least one processor operable to read the program code and operate as instructed by the program code, the program code including a first prediction model and an optimizer in a control loop, the program code causing the at least one processor to:
in the control loop,
measure a difference between an output of the first prediction model and a reference,
calculate a correction parameter based on the measured difference,
apply, at a first update rate, the correction parameter to the first prediction model output to update the first prediction model, and,
adjust the physical system based on the updated first prediction model,
the program code further including a second prediction model, the program code causing the at least one processor to:
update the first prediction model using the second prediction model at an update rate different than the update rate of the first prediction model.

2. The model predictive control system of claim 1, wherein the second predictive model is more complex than the first predictive model.

3. The model predictive control system of claim 1, wherein the update to the first prediction model using the second prediction model is carried out at regularly recurring intervals.

4. The model predictive control system of claim 1, wherein the update to the first prediction model using the second prediction model is carried out in response to a triggering event.

5. The model predictive control system of claim 4, wherein the triggering event is a signal from a timer.

6. The model predictive control system of claim 4, wherein the triggering event is the receipt of a sampling input from the physical system.

7. The model predictive control system of claim 1, further comprising an update node for triggering an update of the first prediction model.

8. The model predictive control system of claim 1, wherein the physical system is a machine or a plant.

9. The model predictive control system of claim 1, wherein the plant is a MIMO plant.

10. The model predictive control system of claim 1, further comprising plurality of MPC controllers and plants connected to the second predictive controller.

11. A method for controlling the operation of a physical system using a model predictive control (MPC) controller, using at least one processor, the method comprising:
in a control loop,
generating a first prediction model,
measuring a difference between an output of the first prediction model and a reference,
calculating a correction parameter based on the measured difference,
applying, at a first update rate, the correction parameter to the first prediction model output to update the first prediction model, and,
adjusting the physical system based on the updated first prediction model,
generating a second prediction model and updating the first prediction model using the second prediction model at an update rate different than the update rate of the first prediction model.

12. The method for controlling the operation of a physical system of claim 11, wherein the second predictive model is more complex than the first predictive model.

13. The method for controlling the operation of a physical system of claim 11, wherein the update to the first prediction model using the second prediction model is carried out at regularly recurring intervals.

14. The method for controlling the operation of a physical system of claim 11, wherein the update to the first prediction model using the second prediction model is carried out in response to a triggering event.

15. The method for controlling the operation of a physical system of claim 14, wherein the triggering event is a signal from a timer.

16. The method for controlling the operation of a physical system of claim 14, wherein the triggering event is the receipt of a sampling input from the physical system.

17. The method for controlling the operation of a physical system of claim 11, further comprising an update node for triggering an update of the first prediction model.

18. The method for controlling the operation of a physical system of claim 11, wherein the physical system is a machine or a plant.

19. The method for controlling the operation of a physical system of claim 11, wherein the plant is a MIMO plant.

20. The method for controlling the operation of a physical system of claim 11, further comprising a plurality of MPC controllers and plants connected to the second predictive controller.
